(19) United States
(12) Patent Application Publication
(10) Pub. No.: US 2010/0238484 A1
(43) Pub. Date: Sep. 23, 2010

(54) METHOD FOR ESTIMATING PROCESSING TIME FOR A PRINTER AND RELATED APPLICATIONS

(75) Inventor: Naoki KOMINE, Hawthorne, CA (US)

Correspondence Address: Chen Yoshimura LLP;Attention Ying Chen, 333 W. El Camino Real, Suite 380, Sunnyvale, CA, 94087, US

(73) Assignee: KONICA MINOLTA SYSTEMS LABORATORY, INC., Huntington Beach, CA (US)

(21) Appl. No.: 12/409,196

(22) Filed: Mar. 23, 2009

(51) Int. Cl. G06F 3/12

(52) U.S. Cl. 358/1.15

(57) ABSTRACT

An algorithm implemented in a print shop management system for estimating a processing time of a print job by a printer, i.e., how long the print job will take to complete printing and inline finishing, is disclosed. The algorithm takes into account the job's printing requirements and the printer' capabilities in determining the processing time. The estimated processing time is used to improve work flow management of the print shop. Practical applications include: using the estimated processing time to improve print job assignment by the management system; displaying the status of a print job that has been submitted to a printer to show a real-time estimate of when the job will complete the processing; generating an alert prior to a time by which the job must start in order to meet a deadline; and informing downstream operators when the print job will proceed to the next step in the workflow.

### BACKGROUND OF THE INVENTION

1. Field of the Invention

This invention relates to a method for estimating processing time for a print job, as well as related practical applications of the method in a print shop environment.

2. Description of Related Art

In an environment that processes a large number of print jobs using multiple printers and finishing devices, there has been a need to manage print jobs efficiently in an organized fashion. Examples of such an environment are professional print shops and print/copy departments at large organizations, where a variety of print requests, such as large-volume duplication and large document printing, needs to be processed and completed by utilizing multiple printers within a short turn-around time. These environments are collectively referred to as “print shops” in this application. Typically, each print job includes a source file that electronically contains a document to be printed, as well as a job ticket that specifies the various requirements for the print job such as paper requirements, layout requirements, finishing requirements, etc. A computer-implemented print shop management system manages the print jobs, including submitting each print job to one or more printers and finishing devices to produce the print job. Conventionally, the print shop management system does not provide an accurate estimate of how long each print job will take to finish printing.

In a typical office environment where one or more client computers are connected to one or more printers but without a central print job management server, some printers can estimate printing time for each job submitted to their queues and can implement a job scheduling function to schedule the jobs in the queue to ensure timely completion of the jobs. Such features are implemented on individual printers and the scheduling is done for jobs in individual queues.

### SUMMARY

The present invention is directed to a method of estimating a processing time of a print job and its practical applications.

An object of the present invention is to provide an improved print shop management system for more efficient management of print shop work flow.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method implemented in a print shop management apparatus, the print shop management apparatus being connected to a plurality of printers in a print shop, the method including: (a) receiving a print job, the print job specifying a document to be printed and a plurality of printing requirements; (b) identifying all candidate printers among the plurality of printers that have capabilities satisfying all printing requirements of the print job; and (c) calculating a processing time for the print job by each candidate printer based on the printing requirements and the capabilities of the candidate printer.

In another aspect, the present invention provides a method implemented in a print shop management apparatus, the print shop management apparatus being connected to a plurality of printers in a print shop, the method including: (a) for each pending print job in a queue of each printer, calculating a processing time for the print job based on printing requirements of the print job and capabilities of the associated printer; (b) continuously determining any delay of each printer due to error conditions; and (c) calculating a time of completion of a target print job in a queue of a printer based on the processing time of the target print job and all print jobs in the same queue ahead of the target print job calculated in step (a) and any delay determined in step (b).

In another aspect, the present invention provides a method implemented in a print shop management apparatus, the method including: (a) calculating a processing time for a print job by a selected printer based on printing requirements of the print job and capabilities of the printer; (b) based on a pre-determined deadline for the print job and the processing time calculated in step (a), determining a start time by which the print job is to be submitted to the printer in order to complete by the deadline; and (c) generating an alert prior to the start time determined in step (b).

In another aspect, the present invention provides a method implemented in a print shop management apparatus, the print shop management apparatus being connected to a plurality of printers in a print shop, the method including: (a) for each pending print job in a queue of each printer, calculating a processing time for the print job based on printing requirements of the print job and capabilities of the associated printer; (b) continuously determining any delay of each printer due to error conditions; (c) calculating a wait time for each printer queue based on the processing times of all pending print jobs in the queue calculated in step (a) and any delay determined in step (b); and (d) based on the wait time calculated in step (c) and based on printing requirements of a target print job and capabilities of the printers, determining an earliest time of completion for the target print job.

In another aspect, the present invention provides a method implemented in a print shop management apparatus for estimating a processing time of a print job by a printer, the printer including one or more finishing units for performing finishing operations, the method including: (a) calculating a printing time based on a total number of color pages of the print job, a total number of black and white pages of the print job, a color printing speed of the printer, and a black and white printing speed of the printer; (b) calculating a finishing time based on a per-page finishing time cost, a total number of pages of the print job, a per-set finishing time cost and a copy count of the printing job; and (c) calculating the processing time by summing the printing time and the finishing time.

In another aspect, the present invention provides a computer program product comprising a computer usable medium having a computer readable program code embedded therein configured to cause a print shop management apparatus to perform the above methods.

It is to be understood that both the foregoing general description and the following detailed description are exemplary and explanatory and are intended to provide further explanation of the invention as claimed.

### BRIEF DESCRIPTION OF THE DRAWINGS

FIGS. 1a and 1b illustrate methods for print job assignment according to embodiments of the present invention.

FIG. 2 illustrates a method for monitoring print job status according to an embodiment of the present invention.

FIG. 3 illustrates a method for generating must-start time alert according to an embodiment of the present invention.

FIG. 4 illustrates a method for estimating time of completion of a print job according to an embodiment of the present invention.

FIG. 5 illustrates a method for estimating earliest time of completion of a print job according to an embodiment of the present invention.

FIG. 6 shows a print shop system according to an embodiment of the present invention.

### DETAILED DESCRIPTION OF PREFERRED EMBODIMENTS

Embodiments of the present invention provide an algorithm implemented in a print shop management system for estimating how long a print job will take to complete printing and finishing (referred to as processing time here), and for using this information to improve work flow management of the print shop.

The algorithm and related methods are implemented by print shop management system software, which is stored in a storage (e.g., a hard disk drive) of a print shop management apparatus 1 (e.g. a computer) and executed by the print shop management apparatus 1. The print shop management apparatus 1 is connected to the printers 2 and other devices of the print shop through a data communication system, such as an LAN (Local Area Network), as schematically shown in FIG. 6.

The algorithm takes into account the job's printing requirements and the printers' capabilities in determining the estimated processing time. The printing requirement of a job includes, for example, the number of pages in the document to be printed, the copy count of the job (how many copies of the document are to be printed), the duplex/simplex mode setting of the job, the color intent of the job (color, black and white (B&W), or mixed color and B&W), the finishing requirements of the job, etc. The printer capabilities include the engine speed (e.g., the page per minute (PPM) count of the printer), the speed of inline finishing operations, etc. The engine speed is typically dependent on the printing requirements; for example, an engine typically has different speeds for color and B&W printing and different speeds for simplex and duplex printing. The processing time is estimated using the appropriate printer capabilities according to the printing requirements of the job.

An exemplary processing time estimation algorithm is described below. This is an example only; other suitable algorithms may be implemented. First, the total number of color pages and B&W pages in the print job are calculated. The total numbers equal the numbers of color and B&W pages, respectively, in the document to be printed multiplied by the copy count of the job. Then, the duplex/simplex mode setting of the job is checked. The corresponding engine speeds for the duplex or simplex mode and for color and/or B&W printing are obtained. Printers typically print color and B&W pages at different speeds; some printers also perform duplex and simplex operations at different speeds. Then, the total numbers of color and B&W pages are divided by the corresponding engine speeds to obtain the time estimate for the printing process.

Next, if the print job requires inline finishing operations, the time required for each finishing operation is estimated. Inline finishing refers to finishing operations performed by a finishing unit that is a part of the printer or connected with the printer, so that it does not require an operator to transport the output of the printer to a separate finishing device. Some finishing operations are performed on a cumulative basis, such as stapling (one operation per set), while some are performed on a per-sheet basis, such as punch. The time required for each finishing operation is estimated accordingly. Thus, the total processing time estimate for the job, including both printing and inline finishing, is calculated as follows:

$$Estimated Processing Time = Total Color Pages / Engine Color Speed + Total B \& W Pages / Engine B \& W Speed + \text{Per-Page Finishing Time Cost} \times \text{Total Pages} + \text{Per-Set Finishing Time Cost} \times \text{Copy count of the job}$$

In the above formula, the per-page finishing time cost is the sum of time costs of all per-page finishing operations and the per-set finishing time cost is the sum of time costs of all per-set finishing operations. In addition to the finishing operations mentioned above, other examples of inline finishing include booklet making/saddle stitching, folding, wire binding, etc.

The estimated processing time can be used to improve various aspects of the print shop management system and the work flow of print jobs. Some of the application scenarios are described in more detail below.

In a first example, the estimated processing time is used to improve print job assignment by the management system. A print job assignment method is described in commonly owned U.S. patent application Ser. No. 12/028,971, filed Jan. 11, 2008, entitled “Print Job Assignment Method Allowing User-Prioritization”. As described in that application, each print job received by the print shop management system is processed by comparing the printing requirements of the job with capabilities of the printers managed by the management system. If a printer cannot satisfy all printing requirements of the job, it is eliminated as a candidate printer. Then, from all candidate printers that can satisfy all printing requirements of the job, one printer is selected for submitting the job, either based on a pre-defined priority preference or by selecting a printer with the shortest wait time. The last step of the above method can be modified by using the estimated processing time according to an embodiment of the present invention.

Specifically, as shown in FIG. 1a, after the print shop management system identifies all candidate printers that can satisfy all printing requirements of the job (step S11), the management system calculates the estimated processing time by each candidate printer (i.e., the time it would take for each printer to process the job) (step S12), and displays the result to the operator (step S13), so that the operator can select a desired printer to submit the job thereto (step S14). Alternatively, as shown in FIG. 1b, after identifying the candidate printers (step S11) and calculating the estimated processing time by each candidate printer (step S12), the management system automatically submits the job to the candidate printer that has the shortest estimated processing time (step S15). Such a job assignment method can improve productivity and the overall workflow.

In a second example, the print shop management system displays the status of a print job that has been submitted to a printer, showing a real-time estimate of when the job will complete the printing and finishing operations (referred to as time of completion here, which can be either a time of the day or a relative time from the current moment). The algorithm for estimating the time of completion takes the following into consideration: the estimated processing time for the target job (the job being monitored), the estimated processing time for each pending job assigned to the same printer ahead of the target job (all such jobs are stored in the printer's queue), jam and other error conditions which may introduce delays and affect the time of completion for all jobs in the queue, etc.

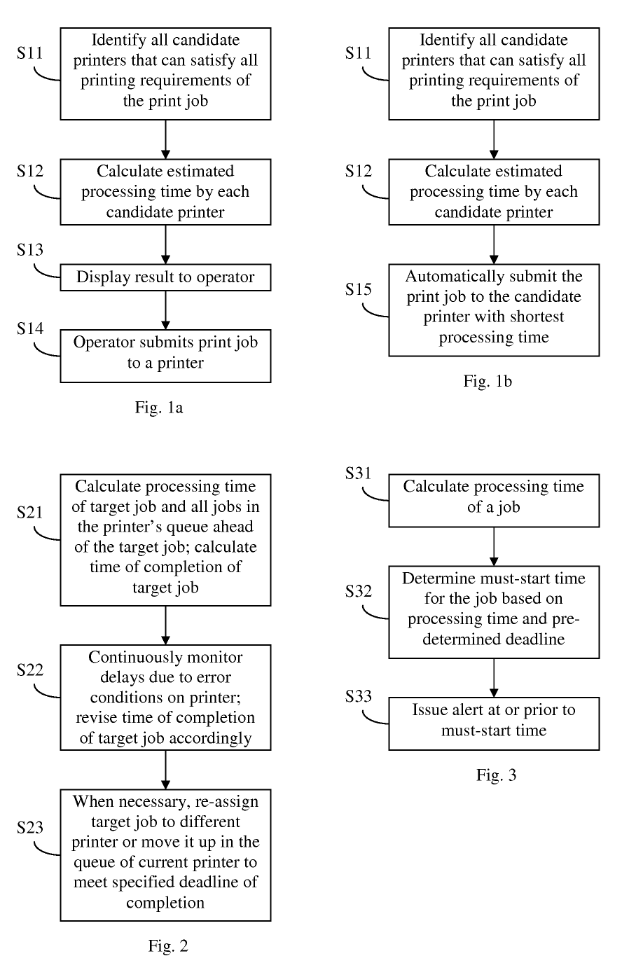

As shown in FIG. 2, the time of completion is estimated using the processing time of the target job and of all jobs in the printer's queue ahead of the target job (step S21). For the job currently being printed, the remaining processing time is estimated. Any delays due to jam or other errors are continuously monitored and added to the cumulative wait time, so that the time of completion of the target job is continuously revised in real-time (step S22). For example, if the engine encounters a jam condition, for every second that the engine is halted until the jam is resolved, one second is added to the estimate time of completion of the target job.

If the target print job has been given a deadline to complete processing, the time of completion information may be used to actively assess whether the job is able to complete to meet the required deadline. A deadline may be imposed by practical considerations such as customer-required pickup time, deadline for shipping, etc. Further, if the target job is unable to meet the specified deadline due to the cumulative wait time on the current printer (i.e. the time of completion is later than the deadline), it may be re-assigned to a different printer (another candidate printer that has been previously determined to be able to satisfy all printing requirements of the job) or be moved up in the current printer's queue to ensure timely completion (step S23). The re-assignment may be done by an operator or done automatically by the print shop management system.

In a third example, the print shop management system uses the estimated processing time for a job to generate an alert to remind the operator that the job must be started by a certain time in order to meet a pre-determined deadline. As illustrated in FIG. 3, the print shop management system calculates the estimated processing time for the job by a selected printer (step S31), determines the must-start time by subtracting the processing time from the pre-determined deadline (step S32), and generates the alert at or before the must-start time (step S33) to give the operator time to prepare and start the job. Optionally, the calculation in step S32 may include a consideration of a “buffer time” in order to give room for error or other delay. Thus, step S32 may further subtract a predetermined buffer time from the pre-determined deadline to calculate the must-start time. More broadly, the print shop management system may use the estimated processing time for all jobs to schedule the jobs so that as many jobs as possible will meet their deadlines. Scheduling algorithms are generally known in computer science and other fields, and any such algorithms may be implemented once the estimated processing times for all jobs are calculated.

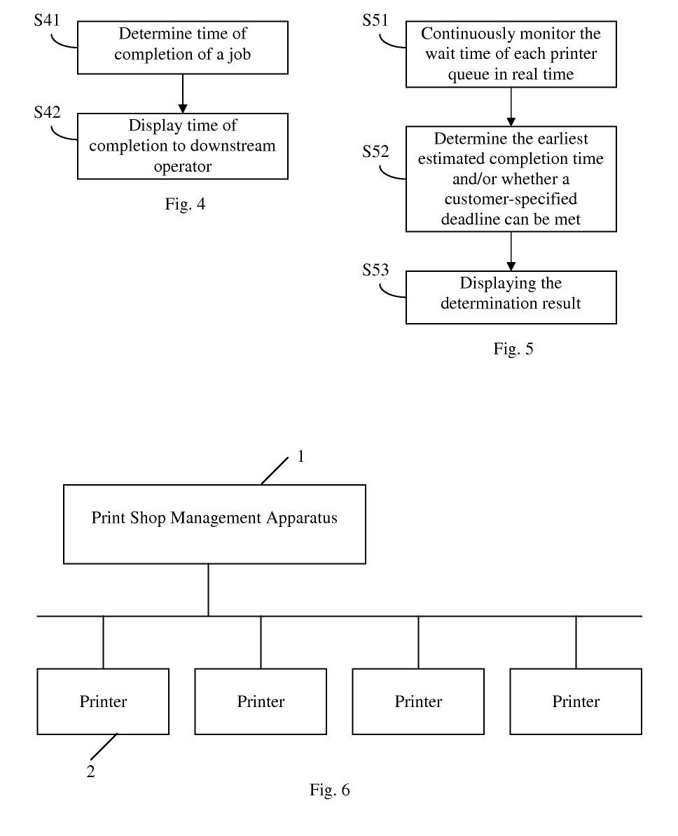

In a fourth example, when the print job requires further processing downstream, such as offline finishing, boxing and shipping, etc., the print shop management system informs downstream operators when the print job will proceed to the next step in the workflow. Offline finishing refers to finishing operations handled by standalone finishing machines that are not coupled to the printer. It typically requires an operator to manually transport the printed output from the printer to the finishing machines, and may also require the operator to manually operate the finishing machine to perform the finishing operation. Thus, informing the downstream operator when the printing will complete allows the downstream operator to be prepared for the next step operation and to more efficiently utilize the downtime when the job is printing. As shown in FIG. 4, the print shop management system determines the time of completion for the job (step S41) and displays the time of completion to the downstream operator (step S42). The step of determining the time of completion (step S41) may include the steps S21 and S22 shown in FIG. 2, i.e., by calculating the processing time of the target job and other pending jobs in the same queue ahead of the target job and by taking into account any delay due to error conditions of the printer.

In a fifth example, the estimated job processing time is used to determine whether a customer-requested deadline can be met. As shown in FIG. 5, the print shop management system continuously monitors the wait time of each printer queue in real time (step S51). This is accomplished by estimating the cumulative processing time for all pending jobs in the printer queue, and continuously monitoring any delay due to jam and other error conditions of the printer (similar to steps S21 and S22 of FIG. 2). Then, when a customer wishes to submit a print job request to the print shop, the print shop management system determines, based on the printing requirements of the job, what the earliest estimated time of completion will be and/or whether a customer-specified deadline can be met (step S52). This is accomplished by identifying all candidate printers the job can be assigned to based on the printing requirements of the job (similar to step S11 in FIG. 1a), calculating the estimated processing time for the job by each candidate printer (similar to step S12 in FIG. 1a), adding the corresponding processing time to the wait time of each candidate printer determined in step S51 to arrive at the time of completion by each candidate printer, and identifying the earliest time of completion.

The determination result of step S52 is displayed (step S53), so that the print shop staff can advise the customer accordingly before the customer actually submits the job to the print shop. This feature is also helpful when the print shop has a web based online job submission system. With such as system, a customer can specify the printing requirements over the Internet, and the determination result of step S52 is transmitted to the customer over the Internet and displayed to the customer (step S53) so that the customer can decide whether to submit the print job to the print shop.

From the above descriptions it can be seen that having an accurate estimate of processing time enables the print shop to improve management of work flow and human operators. It can help operators decide what printer a job should be submitted to for processing. For jobs that have already been submitted, it can provide real-time estimate of time of completion for each job, allowing operators of downstream processing operations to prepare for such operations. It can help the print shop ensure on time delivery of customer's print jobs.

In the above descriptions, the term “printing” broadly encompasses copying, e.g., making multiple copies from an original hard copy document. Copying typically involves scanning the hard copy and printing multiple copies. Further, the term “printer” broadly encompasses any devices that produce printed copies, including copiers and printers having inline finishing units.

It will be apparent to those skilled in the art that various modification and variations can be made in the processing time estimating method and related practical applications of the present invention without departing from the spirit or scope of the invention. Thus, it is intended that the present invention cover modifications and variations that come within the scope of the appended claims and their equivalents.

What is claimed is:

1. A method implemented in a print shop management apparatus, the print shop management apparatus being connected to a plurality of printers in a print shop, the method comprising:
(a) receiving a print job, the print job specifying a document to be printed and a plurality of printing requirements;
(b) identifying all candidate printers among the plurality of printers that have capabilities satisfying all printing requirements of the print job; and
(c) calculating a processing time for the print job by each candidate printer based on the printing requirements and the capabilities of the candidate printer.

2. The method of claim 1, wherein step (c) comprises, for each candidate printer:
(c1) calculating a printing time based on a total number of color pages of the print job, a total number of black and white pages of the print job, a color printing speed of the printer, and a black and white printing speed of the printer;
(c2) calculating a finishing time based on a per-page finishing time cost, a total number of pages of the print job, a per-set finishing time cost and a copy count of the printing job; and
(c3) calculating the processing time by summing the printing time and the finishing time.

3. The method of claim 1, further comprising:
(d) submitting the print job to a selected candidate printer having a shortest processing time for the print job based on the processing times calculated in step (c).

4. The method of claim 1, further comprising:
(d) displaying the processing times calculated in step (c) to an operator.

5. A method implemented in a print shop management apparatus, the print shop management apparatus being connected to a plurality of printers in a print shop, the method comprising:
(a) for each pending print job in a queue of each printer, calculating a processing time for the print job based on printing requirements of the print job and capabilities of the associated printer;
(b) continuously determining any delay of each printer due to error conditions; and
(c) calculating a time of completion of a target print job in a queue of a printer based on the processing time of the target print job and all print jobs in the same queue ahead of the target print job calculated in step (a) and any delay determined in step (b).

6. The method of claim 5, wherein step (a) comprises, for each pending print job:
(a1) calculating a printing time based on a total number of color pages of the print job, a total number of black and white pages of the print job, a color printing speed of the associated printer, and a black and white printing speed of the associated printer;
(a2) calculating a finishing time based on a per-page finishing time cost, a total number of pages of the print job, a per-set finishing time cost and a copy count of the printing job; and
(a3) calculating the processing time by summing the printing time and the finishing time.

7. The method of claim 5, further comprising:
(d) if the time of completion calculated in step (c) is later than a pre-determined deadline for the target print job, re-assigning the target print job to another printer or moving the target print job up in the queue.

8. The method of claim 5,
(d) displaying the time of completion calculated in step (c) to an operator of a downstream processing operation for the print job.

9. A method implemented in a print shop management apparatus, the method comprising:
(a) calculating a processing time for a print job by a printer based on printing requirements of the print job and capabilities of the printer;
(b) based on a pre-determined deadline for the print job and the processing time calculated in step (a), determining a start time by which the print job is to be submitted to the printer in order to complete by the deadline; and
(c) generating an alert at or prior to the start time determined in step (b).

10. The method of claim 9, wherein step (a) comprises:
(a1) calculating a printing time based on a total number of color pages of the print job, a total number of black and white pages of the print job, a color printing speed of the printer, and a black and white printing speed of the printer;
(a2) calculating a finishing time based on a per-page finishing time cost, a total number of pages of the print job, a per-set finishing time cost and a copy count of the printing job; and
(a3) calculating the processing time by summing the printing time and the finishing time.

11. A method implemented in a print shop management apparatus, the print shop management apparatus being connected to a plurality of printers in a print shop, the method comprising:
(a) for each pending print job in a queue of each printer, calculating a processing time for the print job based on printing requirements of the print job and capabilities of the associated printer;
(b) continuously determining any delay of each printer due to error conditions;
(c) calculating a wait time for each printer queue based on the processing times of all pending print jobs in the queue calculated in step (a) and any delay determined in step (b); and
(d) based on the wait time calculated in step (c) and based on printing requirements of a target print job and capabilities of the printers, determining an earliest time of completion for the target print job.

12. The method of claim 11, wherein step (a) comprises, for each pending print job:
(a1) calculating a printing time based on a total number of color pages of the print job, a total number of black and white pages of the print job, a color printing speed of the associated printer, and a black and white printing speed of the associated printer;
(a2) calculating a finishing time based on a per-page finishing time cost, a total number of pages of the print job, a per-set finishing time cost and a copy count of the printing job; and
(a3) calculating the processing time by summing the printing time and the finishing time.

13. The method of claim 11, wherein step (d) comprises:
(d1) identifying all candidate printers among the plurality of printers that have capabilities satisfying all printing requirements of the target print job; and
(d2) calculating a processing time for the target print job by each candidate printer based on the printing requirements of the target print job and the capabilities of the candidate printer; and
(d3) determining the earliest time of completion based on the wait times calculated in step (c) and the processing times calculated in step (d2).

14. A method implemented in a print shop management apparatus for estimating a processing time of a print job by a printer, the printer including one or more finishing units for performing finishing operations, the method comprising:
(a) calculating a printing time based on a total number of color pages of the print job, a total number of black and white pages of the print job, a color printing speed of the printer, and a black and white printing speed of the printer;
(b) calculating a finishing time based on a per-page finishing time cost, a total number of pages of the print job, a per-set finishing time cost and a copy count of the printing job; and
(c) calculating the processing time by summing the printing time and the finishing time.

15. The method of claim 14, wherein the finishing operations include a hole punching operation and a stapling operation, wherein the per-page finishing time cost includes a time cost of the hole punching operation and the per-set finishing time cost includes a time cost of the stapling operation.
